(19) United States
(12) Patent Application Publication
(10) Pub. No.: US 2011/0018930 A1
(43) Pub. Date: Jan. 27, 2011

(54) FEED SLOT PROTECTIVE COATING

(76) Inventors: Siddhartha Bhwomik, Salem, OR (US); Lawrence H. White, Corvallis, OR (US); Satya Prakash, Poway, CA (US); Rio T. Rivas, Corvallis, OR (US); Samuel Ajayi, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/933,228

(22) PCT Filed: Apr. 30, 2008
(86) PCT No.: PCT/US08/62121

§ 371 Date: Sep. 17, 2010

(51) Int. Cl. B41J 2/165; B05D 5/00

(52) U.S. Cl. 347/22; 427/247

(57) ABSTRACT

An apparatus and method provide a protective coating (60) that extends within a feed slot (40) and is limited so as to not extend into a firing chamber (47).

### BACKGROUND

Printing devices utilize print heads to selectively deposit fluid, such as inks, onto print media. Over time, the print heads degrade, reducing print quality.

### BRIEF DESCRIPTION OF THE DRAWINGS

FIG. 1 is a front elevational view of a printer according to an example embodiment.

FIG. 2 is an exploded bottom perspective view of a print cartridge of the printer of FIG. 1 according to an example embodiment.

FIG. 3 is a sectional view of the cartridge of FIG. 2 taken along line 3-3 according to an example embodiment.

FIG. 4 is a sectional view of a print head die of the cartridge of FIG. 3 prior to opening of a fluid feed slot according to an example embodiment.

FIG. 5 is a sectional view of a print head die of the cartridge of FIG. 3 after opening of a fluid feed slot according to an example embodiment.

FIG. 6 is an enlarged fragmentary sectional view of another embodiment of a print head die of the cartridge of FIG. 3 according to an example embodiment.

FIG. 7 is an enlarged fragmentary view of the print head die of FIG. 6 taken along line 7-7 according to an example embodiment.

FIG. 8 is an enlarged fragmentary sectional view of the die of FIG. 6 taken along line 8-8 according to example embodiment.

FIG. 9 is a fragmentary top elevational view of a print head assembly including the print head die of FIG. 7 according to an example embodiment.

### DETAILED DESCRIPTION OF THE EXAMPLE EMBODIMENTS

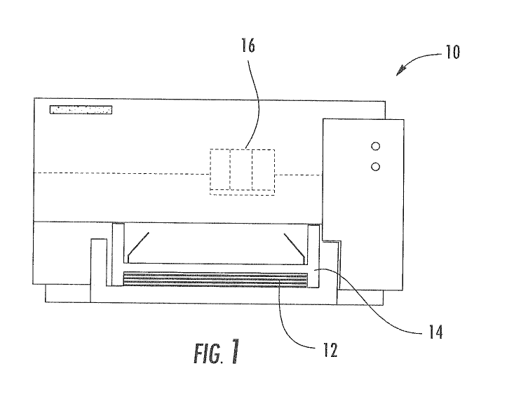

FIG. 1 illustrates one example of a printing device 10 according to an example embodiment. Printing device 10 is configured to print or deposit ink or other fluid onto a print media 12, such as sheets of paper or other material. Printing device 10 includes a media feed 14 and one or more print cartridges 16. Media feed 14 drives or moves media 12 relative to cartridges 16 which eject ink or fluid onto the medium. In the example illustrated, cartridges 16 are driven or scanned transversely across media 12 during printing. In other embodiment, cartridges 16 maybe stationary and may extend substantially across a transverse width the media 12.

As will be described hereinafter, print cartridges 16 include print head dies that have fluid feed slots that are provided with a protective coating which does not extend into the firing chamber. The protective coating inhibits or reduces corrosion of the die due to its interaction with the fluid or ink while not substantially interfering with the ejection of ink from the firing chamber. As a result, print quality over the life of print cartridge 16 maybe enhanced or prolonged.

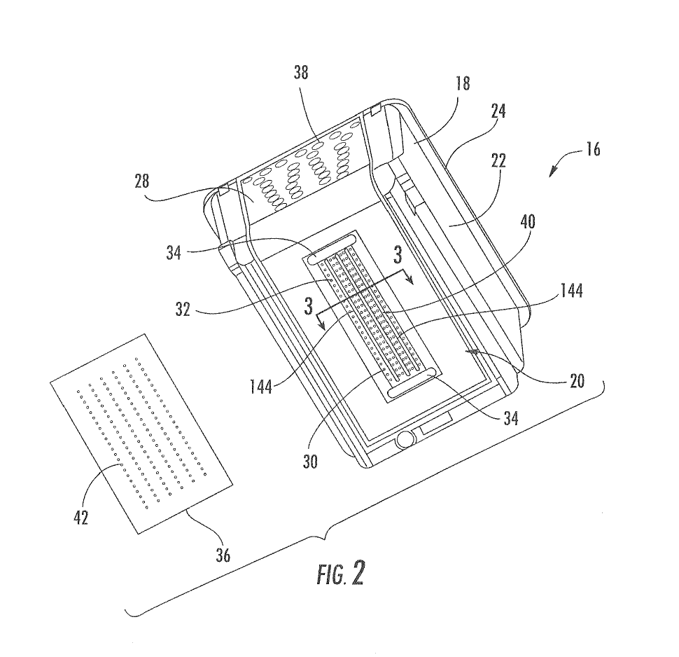

FIG. 2 illustrates one of cartridges 16 in more detail. As shown by FIG. 2, cartridge 16 includes fluid reservoir 18 and head assembly 20. Fluid reservoir 18 comprises one or more structures configured to supply fluid or ink to head assembly 20. In one embodiment, fluid reservoir 18 includes a body 22 and a lid 24 which form one or more internal fluid chambers that contain fluid, such as ink, which is discharged through slots or openings to head assembly 20. In one embodiment, the one or more internal fluid chambers may additionally include a capillary medium (not shown) for exerting a capillary force on the printing fluid to reduce the likelihood of the printing fluid leaking. In one embodiment, each internal chamber of fluid reservoir 18 may further include an internal standpipe (not shown) and a filter across the internal standpipe. In yet another embodiment, fluid reservoir 18 may have other configurations. For example, although fluid reservoir 18 is illustrated as including a self-contained supply of one or more types of fluid or inks, in other embodiments, fluid reservoir 18 may be configured to receive fluid or ink from an off-axis of fluid supply via one or more conduits or tubes.

Head assembly 20 comprises a mechanism coupled to include reservoir 18 by which the fluid or ink is selectively ejected onto a medium. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

In the embodiment illustrated, head assembly 20 comprises a drop-on-demand inkjet head assembly. In one embodiment, head assembly 20 comprises a thermoresistive head assembly. In other embodiments, head assembly 20 may comprise other devices configured to selectively deliver or eject printing fluid onto a medium.

In the particular embodiment illustrated, head assembly 20 comprises a tab head assembly (THA) which includes flexible circuit 28, print head die 30, firing resistors 32, encapsulate 34 and orifice plate 36. Flexible circuit 28 comprises a band, panel or other structure of flexible bendable material, such as one or more polymers, supporting or containing electrical lines, wires or traces that terminate at electrical contacts 38 and that are electrically connected to firing circuitry or resistors 32 on die 30. Electrical contacts 38 extend generally orthogonal to die 30 and comprise pads configured to make electrical contact with corresponding electrical contacts of the printing device in which cartridge 16 is employed. As shown by FIG. 2, flexible circuit 28 wraps around body 22 of fluid reservoir 18. In other embodiments, flexible circuit 28 may be omitted or may have other configurations where electrical connection to resistors 32 and their associated addressing or firing circuitry is achieved in other fashions.

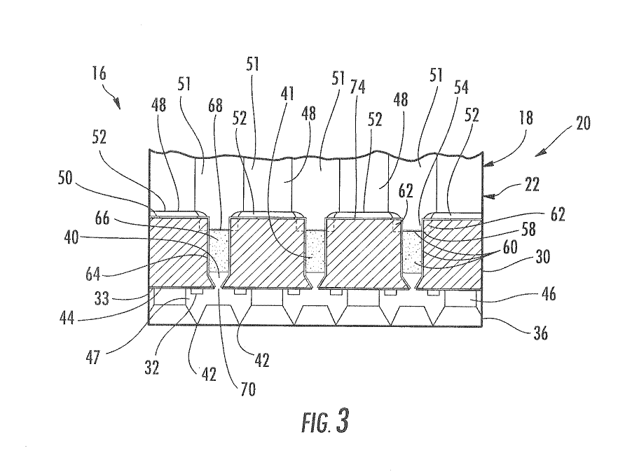

Print head die 30 (also known as a print head substrate or chip) comprises one or more structures coupled between the interior fluid chamber of the reservoir 18 and resistors 32. Print head die 30 delivers fluid to resistors 32. In the particular embodiment illustrated, print head die 30 further supports resistors 32. Print head die 30 includes slots 40 and ribs 41 (shown in FIG. 3). The slots 40 comprise fluid passages or fluid via through which fluid is delivered to resistors 32. Slots 40 have a sufficient length to deliver fluid to each of resistors 32 and their associated nozzles. In one embodiment, slots 40 have a width of between 100 micrometers and 700 micrometers and nominally about 550 micrometers. In the embodiment illustrated in which firing circuitry or resister addressing circuitry is directly provided upon or as part of the chip or die 30, slots 40 have a centerline-to-centerline pitch of approximately 0.8 mm. In embodiments where the firing or addressing circuitry is not provided upon the chip or die 30, slots 40 may have a centerline-to-centerline pitch of approximately 0.5 mm. In other embodiments, slots 40 may have other dimensions and other relative spacings.

Ribs 41 (also known as cross beams) comprise reinforcement structures configured to strengthen and provide rigidity to those portions of print head die 30 between consecutive slots 40 (bars 64). Ribs 41 extend across each of slots 40 generally perpendicular to a major axis along which each of slots 40 extends. In one embodiment, ribs 41 and the center points of ribs 41 are integrally formed as part of the single unitary body with a majority of those portions of print head die 30 on opposite sides of slots 40. As will be described in more detail hereafter, ribs 41 strengthen die 30, permitting slots 40 to be more densely arranged across die 30, without substantially reducing print performance or quality. These structures are also used to physically separate two different fluids or inks.

Resistors 32 comprise resistive elements or firing circuitry coupled to print head die 30 and configured to generate heat so as to vaporize portions of the printing fluid to forcibly expel drops of printing fluid through orifices in orifice plate 36. In one embodiment, resistors 32 (schematically shown) are formed by multiple thin film layers 33 which may also form transistors and contact pads for such resistors 32. In yet other embodiments, the firing circuitry may have other configurations.

Encapsulants 34 comprise one or more material which encapsulate electrical interconnects that interconnect electrically conductive traces or lines associated with die 30 with electrically conductive lines or traces of flexible circuit 28 which are connected to electrical contacts 38. In other embodiments, encapsulates 34 may have other configurations or may be omitted.

Orifice plate 36 comprises a plate or panel having a multitude of orifices which define nozzle openings through which the printing fluid is ejected. Orifice plate 36 is mounted or secured opposite to slots 40 and their associated firing circuitry or resistors 32. In one embodiment, orifice plate 36 comprises a nickel substrate. As shown by FIG. 2, orifice plate 36 includes a plurality of orifices or nozzles 42 through which ink or fluid heated by resistors 32 is ejected for printing on a print medium. In other embodiments, orifice plate 36 may be omitted where such orifices or nozzles are otherwise provided.

Although cartridge 16 is illustrated as a cartridge configured to be removably mounted to or within printer 10, in other embodiments, fluid reservoir 18 may comprise one or more structures which are a substantially permanent part of printer 10 and which are not removable. Although printer 10 is illustrated as a front loading and front discharging desktop printer, in other embodiments, printer 10 may have other configurations and may comprise other printing devices where printer 10 prints or ejects a controlled pattern, image or layout and the like of fluid onto a surface. Examples of other such printing devices include, but are not limited to, facsimile machines, photocopiers, multifunction devices or other devices which print or eject fluid.

FIG. 3 is a sectional view illustrating head assembly 20 in detail. In particular, FIG. 3 illustrates print head die 30 coupled between a lower portion of body 22 of reservoir 18 and orifice plate 36. As shown by FIG. 3, in the example illustrated, print head die 30 has a lower or front side 44 joined to orifice plate 36 by a barrier layer 46. Barrier layer 46 at least partially forms firing chambers 47 between resistors 32 and nozzles 42 of orifice plate 36. In one embodiment, barrier layer 46 may comprise a photo-resist polymer substrate. In one embodiment, barrier layer 46 may be formed from the same material as that of orifice plate 36. In yet another embodiment, barrier layer 46 may form orifices or nozzles 42 such that orifice plate 36 may be omitted. In some embodiments, barrier layer 46 may be omitted.

As shown by FIG. 3, resistors 32 are supported on shelves on opposite sides of slots 40 and generally opposite to nozzles 42 within firing chambers 47. Resistors 32 are electrically connected to contact pads 38 (shown in FIG. 2) by electrically conductive lines or traces (not shown) supported by die 30. Electrical energy supplied to resistors 32 vaporizes fluid supply through slots 40 to form a bubble that forces or ejects surrounding or adjacent fluid through nozzles 42. In one embodiment, resistors 32 are further connected to firing or addressing circuitry also located upon die 30. In another embodiment, resistors 32 may be connected to firing or addressing circuitry located elsewhere.

Body 22 of reservoir 18 includes inter-posers or headlands 48. Headlands 48 comprise those structures or portions of body 22 which are connected to die 30 so as to fluidly seal one or more chambers of reservoir 18 to a second side 50 of die 30. In the example illustrated, headlands 48 connect each of the three separate fluid containing chambers 51 to each of the three slots 40 of die 30. For example, in one embodiment, reservoir 18 may include three separate stand pipes which deliver fluid to each of the three slots 40. In one embodiment, each of the three separate chambers may include a distinct type of fluid, such as a distinct color of fluid or ink. In other embodiments, body 22 of reservoir 18 may include a greater or fewer number of such headlands 48 depending upon the number of slots 40 in die 30 which are to receive different fluids from different chambers in reservoir 18.

In the example illustrated, side 50 of die 30 is adhesively bonded to body 22 by an adhesive 52. In one embodiment, adhesive 52 comprises a glue or other fluid adhesive. In other embodiments, headlands 48 of reservoir 18 may be sealed and joined to die 30 in other fashions.

As further shown by FIG. 3, print head die 30 additionally includes protective coating 60 (enlarged for purposes of illustration). Coating 60 comprises one or more layers of one or more materials that have an outermost surface that is substantially inert to the fluid directed through slots 40 printed die 30. In one embodiment, coating 60 comprises a homogenous single layer of tantalum. In other embodiments, coating 60 may comprise multiple homogenous layers of tantalum. Because coating 60 is formed from tantalum, coating 60 is inert to many fluids or inks that may be especially corrosive with respect to silicon, a material from which print head die 30 may be formed. Because selected other components of head assembly 20 may already include tantalum components, coating 60 may be formed using equipment and supplies that are already present.

In other embodiments, coating 60 may form from other materials that are inert to the fluid being printed. For example, in other embodiment, coating 60 may be formed from metal oxide, metal nitrides, silicon oxide or selected polymers. For example, in one embodiment, such polymers may include, not limited to, carbon fluorine complex polymers which have properties similar to polytetraflouroethylene (TEFLON). As will be described hereafter, in some embodiment, protective coating comprises one or more materials which are configured to be directionally deposited.

Coating 60 or lies or extends over and majority if not all of those surfaces of a print head die 30 that extend opposite to or adjacent to fluid feed slot 40. In the example illustrated, coating 60 is formed and extends over side surfaces 64 of die 30, side surfaces 66 of ribs 41, the top surfaces 68 of ribs 41, and the back face 74 of die 30. Consequently, coating 60 provides a protective blanket over the relatively large surface areas adjacent to slot 40 which may contact fluid as the fluid travels through slot 40. In alternative embodiments, coating 60 either coats a portion or does not coat the back face 74 of die 30. Absence of coating 60 is achieved by conventional techniques such as show masking or liftoff.

It is been found that many fluids or inks, especially high performance inks, tend to corrode the one or more materials of print head die 30 over time. For example, it is been found that many high-performance inks tend to corrode the silicon from which die 30 is formed. The corroded and dissolved silicon contaminates the fluid or the ink and may affect the ejection of the ink by affecting either the quality of the ink itself or by being deposited upon resistors 32 or other components that eject the fluid or the ink. It has also been found that the dissolved silicon contaminants in the fluid or the ink subsequently precipitates out of the ink and becomes deposited in the openings 70 or 42 to at least partially occlude such openings. In certain instances, the silicon growth in the nozzle opening 42 may create novel directionality issues and reduce printing performance.

Coating 60 addresses such issues by insulating the material, such a silicon, forming die 30 from the potentially corrosive fluids or inks. As a result, coating 60 reduces or prevents silicon growth about nozzle opening 42 and reduces the likelihood that the fluid or ink will be contaminated. Consequently, print quality may be maintained and the useful life of print head assembly 20 may be prolonged.

In a particular example illustrated, coating 60 further extends over a back face 74 of die 30 (the backside of the wafer including die 30). As a result, coating 60 further protects a top surface of die 30 during contact with fluid from chambers 51. In addition, those portions of die 30 which are bonded to head lands 48 by adhesive 52 are further benefited. In particular, coating 60 improves adhesion of the materials of die 30 to the structural adhesive 52.

Coating 60 has a sufficient thickness to ensure the integrity of the protective layer formed adjacent to feed slot 40. In the example illustrated in which coating 60 comprises tantalum and the material of die 30 comprises silicon, coating 60 has a thickness or least about 150 Angstroms and nominally greater than about 250 Angstroms.

At the same time, coating 60 has a thickness small enough such that cracking or delamination of coating 60 resulting from tensile stresses is reduced. In the example illustrated, in which one embodiment die 30 is formed from silicon and coating 60 is formed from tantalum, coating 60 comprises a neutral stress film having a thickness of less than or equal to about 5000 Angstroms. In another embodiment, coating 60 comprises a neutral stress film having a thickness of less than or equal to about 2000 Angstroms. It is been found that when coating 60 has a thickness of greater than 2000 Angstroms but less than or equal to about 5000 Angstroms, coating 60 may still undergo some cracking or delamination. In other embodiments, depending upon the composition of coating 60, coating 60 may have other thicknesses.

As shown by FIG. 3, coating 60 is limited such that it terminates prior to extending into firing chambers 47. In one embodiment, coating 60 extends up to and along opening 70 and die 30. In particular embodiments, coating 60 may additionally extend onto portions of orifice plate 36 directly opposite to openings 70. However, even in these embodiments, coating 60 does not laterally extend substantially into firing chambers 47 or over resistors 32. Because the coverage of coating 60 is controlled and limited so as to not extend into firing chambers 47, coating 60 is not interfere with the firing properties, such as a turn on energy, of resistors 32 or those fluid ejection characteristics achieved by the overall firing system. This may be especially important where coating 60 is formed from materials having a relatively low thermal conductivity (a thermal conductivity much lower than the material form of resistors 32) which would otherwise impact the ejection of fluid within each firing chamber 47.

In one embodiment, coating 60 is deposited upon surfaces 64, 66 and 68 using directional deposition techniques which provide control over the direction in which the materials of coating 60 are applied. As noted above, in particular embodiments, coating 60 is formed one or more materials capable of directional deposition. In the example illustrated, coating 60 is deposited upon such surfaces by sputter deposition (also known as physical vapor deposition (PVD) and sometime referred to as plasma deposition). During such deposition, the material, such as tantalum, forming coating 60 is directionally applied to surfaces 64, 66 and 68 so as to not laterally extend into firing chambers 47. In other embodiments, coating 60 may be applied using other directional deposition techniques such as directional evaporation. Such directional deposition techniques control the extent of coating 60.

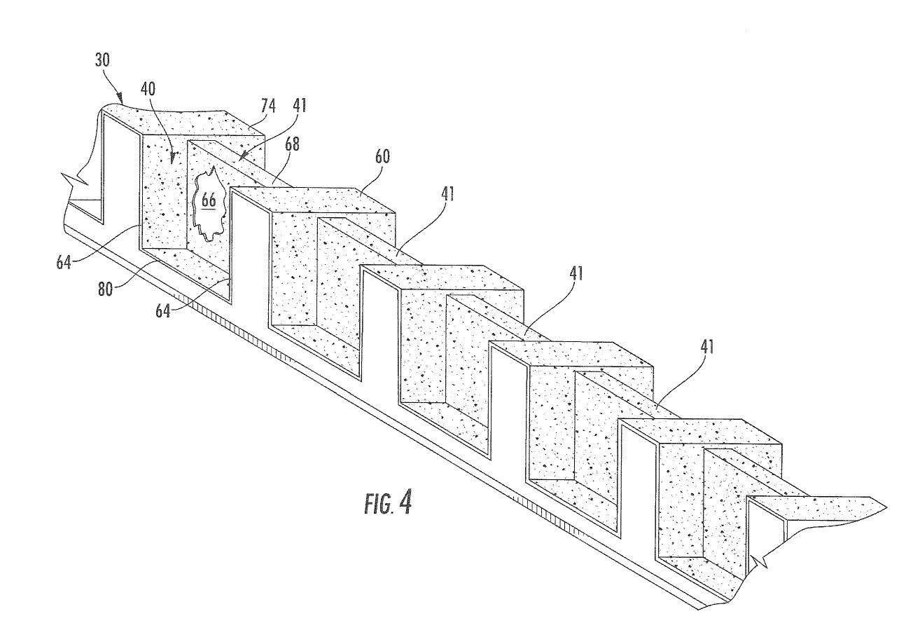

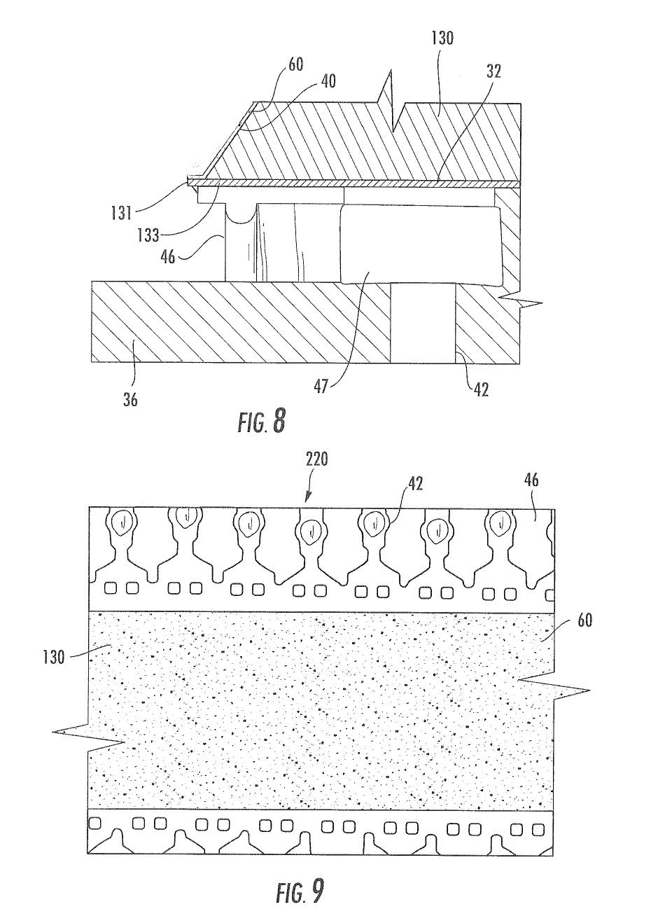

FIGS. 4 and 5 illustrate an alternative method for forming coating 60. FIGS. 4 and 5 illustrate die 30 prior to connection with body 22 or the formation of orifice plate 36 or barrier layer 46 on die 30. As shown by FIG. 8, coating 60 is coated or deposited over each of surfaces 64, 66, 68 and 74 of die 30 adjacent to feed slot 40 and rib 41 prior to the forming of opening 70 (shown in FIG. 3) through a floor 80 of slot 40. As shown by Figure, during such deposition, coating 60 may also extend over at least portions of floor 80. Because floor 80 has not been broken through to form opening 70, floor 80 isolates slot 40 from the resistors 42 and their associated circuitry which may or may not already be formed upon an underside of die 30. As a result, and bottoms were coating 60 is applied prior to formation of firing chambers 47 (shown in FIG. 3 or prior to connection of slot 40 with such firing chambers 47 (shown in FIG. 3), coating this may be applied using non-directional deposition techniques. For example, coating 60 may be blanket coated or applied.

As shown by FIG. 5, after deposition of coating 60, portions of floor 80 are removed or broken through to form opening 70 in die 30. In one embodiment portions of floor 80 are removed with a laser and the opening is formed with a Tetra-methyl ammonium hydroxide (TMAH) or Heated Potassium Hydroxide (KOH) wet etch. Thereafter, die 30 is connected to body 22. Resistors 32 along with their associated circuitry are formed upon a lower face of die 30 if not already existing. Thereafter, barrier layer 46 and orifice plate 36 are also formed on the lower side of die 30. Alternatively, the resistors 32, circuitry, barrier layer 46, and orifice plate 36 are formed on the lower side of die 30 prior to formation of the slot.

Overall, coating 60 allows print head assembly 20 to maintain desired levels of quality over a prolonged period of time. Coating 60 inhibits or prevents fluids or inks from corroding the materials of die 30. Coating 60 inhibits contamination of the food or ink with the dissolved materials of die 30. Coating 60 also inhibits the deposition, build or growth of the dissolved materials of die 30 about opening 70 or nozzle openings 42 and upon resistors 32. At the same time, coating 60 does not potentially interfere with the fluid ejection devices comes at his resistors 32. Coating 60 facilitates the printing of fluids or inks that may be more corrosive to the materials of die 30 yet may provide enhanced performance. Coating 30 provide greater design freedom in the selection of fluid or ink formulations.

In the example illustrated, coating 60 has been described as being applied to both the surfaces of slot 40 and surfaces of rib 41. As a result, a substantial majority of those surfaces of die 30 that may come into contact with the fluid or ink along slot 40 are protected. In other embodiments, not all sources along slot 40 may be coated. For example, in other embodiments, portions of rib 41 may not be coated. In other embodiments, rib 41 may not be coated and/or surfaces 74 of die 30 may alternatively not be coated. In yet other embodiments, die 30 may omit ribs 41, wherein side surfaces 64 of slot 40 are merely coated.

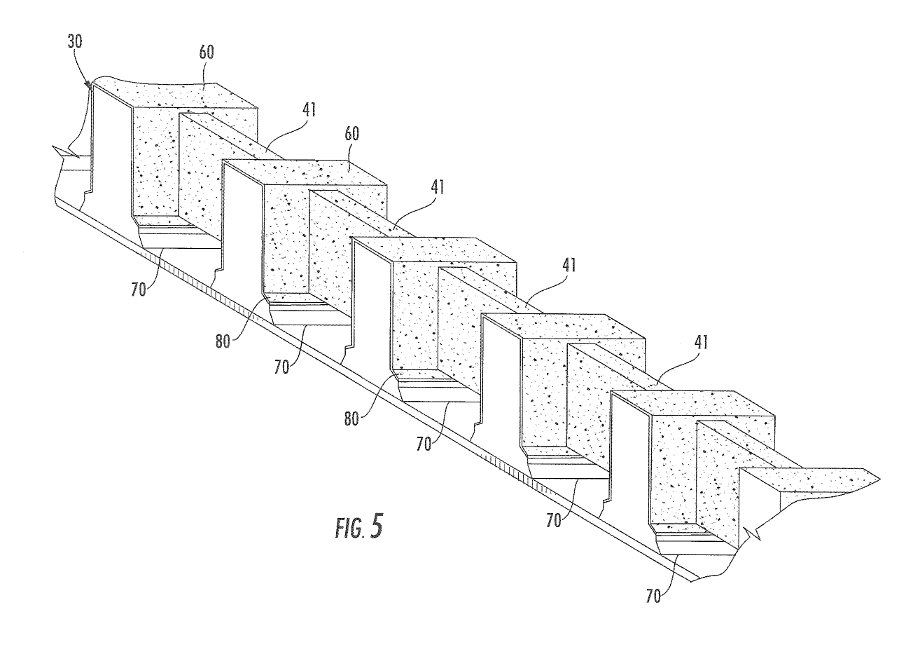

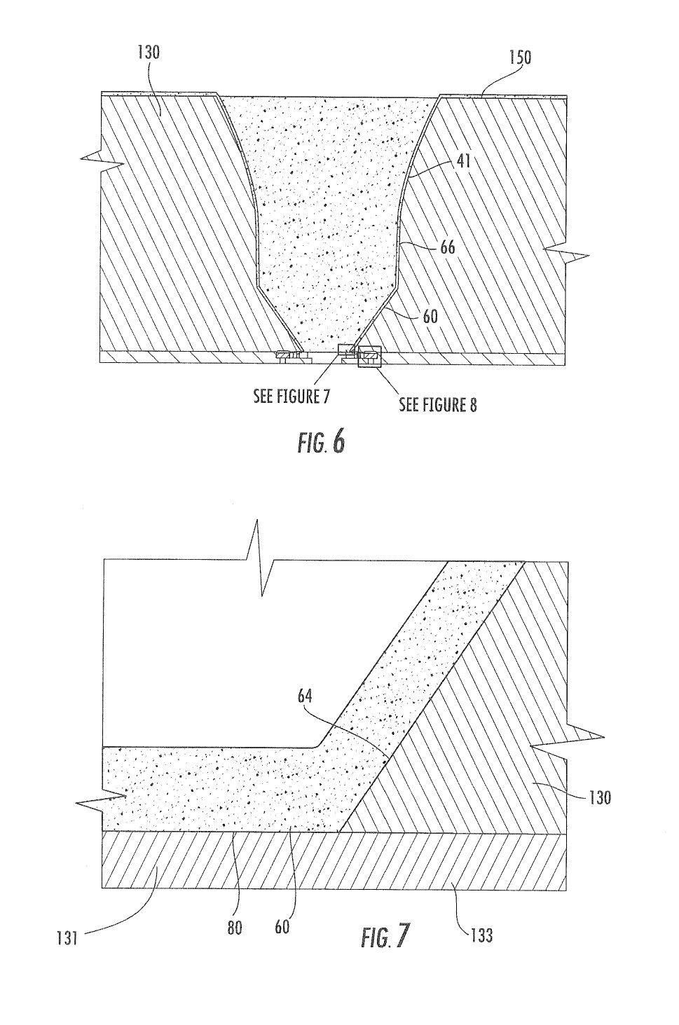

FIGS. 6-8 illustrate die 130, another embodiment of die 30, also including coating 60. Die 130 is similar to die 30 except that die 130 omits ribs 41. Die 130 is formed from silicon. Coating 60 is formed from tantalum deposited by sputter deposition. As shown by FIG. 6, coating 60 extends substantially over all surfaces of die 30 adjacent slot 40 and back face 150. As shown by FIG. 7, coating 60 has a substantially uniform thickness along surfaces 64. As shown by FIG. 7, coating 60 further extends along a cantilever 131 formed by thin film layers 133. The cantilever 131 is formed from anisotropic etching of silicon at opening 71 (shown in FIG. 3). In particular example shown in FIG. 7, coating 60 has a thickness generally ranging from 182 nm to approximate 234 nm. As shown in FIG. 8, coating 60 further extends along those portions of orifice plate 36 (which may be integrally formed along with barrier layer 46 out of a resist material) directly opposite to lower openings in feed slot 40. In particular example illustrated, coating 60 general as a thickness of approximately 40 percent that of the thickness of coating 60 along side surfaces 66 (approximately 195 nm) upon orifice plate 36. However, as further shown by FIG. 8, coating 60 is not present in firing chamber 47 or about nozzle openings 42.

FIG. 9 is a top plan view of print head assembly 220, including die 130 and coating 60, after prolonged period of use. As shown by FIG. 9, coating 60 shows no signs of delamination or cracking. At the same time, nozzle openings 42 show no signs of partial occlusion resulting from the buildup of silicon about such openings. Thus, the print quality achieved by print head assembly to 20 is maintained, potentially extending the life a print head assembly 220.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a die (30, 130) including a fluid feed slot (40);
a firing chamber (47) configured to receive fluid from the feed slot (40); and
a protective coating (60) between the die (30, 130) and the fluid feed slot (40) and contained within the feed slot (40) so as to not extend into the firing chamber (47).

2. The apparatus of claim 1, wherein the protective coating (60) comprises tantalum.

3. The apparatus of claim 1, wherein the protective coating (60) is selected from a group of coatings consisting of metals, metal oxides, metal nitrides, silicon oxide and carbon fluorine complex polymers.

4. The apparatus of claim 1, wherein the die (30, 130) is formed from silicon and wherein the protective coating (60) comprises tantalum.

5. The apparatus of claim 1, wherein the protective coating (60) is formed from a material capable of directional deposition.

6. The apparatus of claim 1, when the protective coating (60) is inert to ink.

7. The apparatus of claim 1, wherein the protective coating (60) comprises tantalum and has a thickness of at least 150 Angstroms.

8. The apparatus of claim 1, wherein the protective coating (60) has a thickness of at least about 250 Angstroms

9. The apparatus of claim 7, wherein the protective coating (60) has a thickness of less than or equal to about 5000 Angstroms.

10. The apparatus of claim 7, wherein the protective coating (60) has a thickness of less than or equal to about 2000 Angstroms.

11. The apparatus of claim 1, where in the protective coating (60) is on the backside of the die (30, 130)

12. A method comprising:
providing a printhead die (30, 130) having a fluid feed slot (40) configured to supply fluid to a fluid firing chamber (47); and
coating (60) the fluid feed slot (40) with a protective coating (60) while maintaining the firing chamber (47) free from the protective coating (60).

13. The method of claim 12, wherein the fluid feed sought is coated with a protective coating (60) prior to formation of the firing chamber (47) or connection of the fluid feed slot (40) to the firing chamber (47).

14. The method of claim 12, wherein the protective coating (60) is applied by directional deposition.

15. The method of claim 12, wherein the coating (60) is tantalum and has a thickness of at least 150 Angstroms.

16. The method of claim 15, wherein the protective coating (60) has a thickness of at least about 250 Angstroms.

17. The method of claim 15, wherein the protective coating (60) has a thickness of less than or equal to about 5000 Angstroms.

18. The method of claim 15, wherein the protective coating (60) has a thickness of less than or equal to about 2000 Angstroms.

19. The method of claim 12, wherein the protective coating (60) is selected from a group of coatings (60) consisting of metals, metal oxides, metal nitrides, silicon oxide and carbon fluorine complex polymers.

20. The method of claim 12, when the protective coating (60) is inert to ink.
